(19) United States
(12) Patent Application Publication
(10) Pub. No.: US 2011/0146150 A1
(43) Pub. Date: Jun. 23, 2011

(54) Integrated planter box/trellis combination

(76) Inventor: Christopher J. Lyon, Redwood City, CA (US)

(21) Appl. No.: 12/655,126

(22) Filed: Dec. 22, 2009

(51) Int. Cl. A01G 9/12

(52) U.S. Cl. 47/70

(57) ABSTRACT

Planter modules, preferably of plastic or fiberglass, are mounted into holes on a one or two layer trellis. Mounting of the planter modules occurs normally after the planter module is filled with a bag of soil and plants are planted into the soil so as to start growing out of a front surface of said planter module. The plants are grown for 1-3 months typically before the planter module is mounted in its hole in the trellis. An array of said planter modules is used. The trellis is then erected and mounted to a wall which is to be converted into a green wall covered by plants. The plants then continue to grow in the planter modules and eventually cover the whole trellis thereby covering the wall.

### BACKGROUND

Plants have been growing on the side of buildings nearly since there have been buildings. Ivy covered walls are known and are especially prevalent in the so-called Ivy League campuses.

There are benefits to having plants on the sides of buildings. First, they are considered beautiful by many. In addition, there is a passive solar design quality to plant covered walls, especially if the plants are deciduous and drop their leaves in the fall. During the summer, the sun's rays stream down on the plants which absorb much of the energy and use it for photosynthesis. This prevents some or most of the energy from reaching the wall and heating it thereby putting more load on the building's air conditioners.

In the winter, most plants lose their leaves, so, if some deciduous plant is covering the wall or walls of the building facing the sun, the sun's rays reach the wall during the winter and heat it which helps heat the building thereby saving energy.

Vines growing on the sides of buildings can also provide water protection to the shell of a building, depending upon the method of construction. However, vines can be a problem for many modern facade construction systems. The physical attachments vines make to the surface of the wall make maintenance of the surface of the wall impossible without an expensive vine removal project. Once the vines are removed, it takes many years for them to grow up and cover the wall again.

Use of a trellis prevents the vine from attaching to the wall. Specifically, a trellis provides a structure for a plant to climb which is not actually part of the wall but is (may be? Not necessarily) attached to the wall. This creates an air space between the trellis and the wall which prevents the vine from actually attaching itself to the wall surface. (this also provides additional benefit over a vine that grows directly on the wall. The airspace acts as an additional insulator that doesn't exist when the vine is grown directly) A trellis can be removed to do maintenance on the wall and then replaced, but if the plant climbing the trellis is growing out of the ground, it makes removing the trellis difficult and the trellis may need to be leaned away from the wall with the plant roots still embedded in the ground.

Also, use of a trellis provides even greater water protection [chris: I do not understand this statement—what kind of water protection and how does the trellis enhance it? Any “horizontally driven” rain water will be blocked from landing on the wall of the building, dripping down the vine and trellis below. It works like the drip line on a tree.]

While use of a trellis on the wall can alleviate the problem of attachment to the wall by a vine, it does not alleviate the problem of the long amount of time it takes for a vine or any other plant to grow from the ground to the top of a tall wall. In most cases of use of a trellis in the prior art, the vines are planted directly in the ground, or into a pot or planter below and sometimes above the trellis panel. The plants, under optimal conditions, may take 3-5 years to cover a 8′ to 10′ trellis.

To make this problem worse, architects and designers often try to grow plants up trellises far higher than is realistic based upon the root space allocated to the plant. Unfortunately, most commercial applications are not optimal for these reasons. Plants growing from the ground up a trellis are limited to covering walls 20′ high or less and even that takes a very long time. The end result is that many trellises are installed today which never end up covered with vines. Building owners are simply not willing to wait the time it takes for the plants to grow up and cover the trellis to achieve the desired look for the building.

Trellis construction has evolved over the years, and recently a new style of double-wire-grid trellis has been introduced which has become more popular in newer construction projects. This double-wire-grid trellis provides a higher level of protection for the plant, a greater area on which to grow, and is more robust for commercial applications.

More recently, a new approach to the problem of creating green walls has been developed. In this prior art approach, commonly referred to in the trade as a “living wall”, lightweight, engineered soil blend is put inside a container. The desired plants are then planted in the soil blend mixture and grown while the container sits on the ground horizontally so the plants grow upward away from the container bottom which is resting on the ground. After the plant has grown sufficiently, the container is then tipped up on its side and attached to the wall of a building. Multiple containers are mounted in this way in a spaced array on the wall. (this is occasionally done this way, but more commonly they are placed in a solid array—the issue isn't the speed with which the wall is covered, but rather the cost—the living wall systems cost on the order of 10× a trellis).The plants then grow up the wall attaching to it in the process, and spreading out. They eventually cover the wall no matter how high it is as long as containers are mounted high enough up on the wall for the plants to reach the top of the wall in a reasonable amount of time. The speed with which the wall can be covered is under control of the designer and shorter intervals to full coverage can be achieved by using more containers and mounting them closer together and mounting some of the containers near enough the top for the plant to reach the top of the wall rapidly.

There are several different living wall systems available in the prior art, and all promise faster, more complete coverage and all allow for a wider range of plants to be used. Some designers are using such living wall systems to “paint pictures” on the wall using living plants.

While this living wall prior art technology is a good solution, it still requires the containers to be physically attached to the wall and requires the wall to be strong enough to support the weight of a number of containers filled with the engineered soil mix possibly soaked with water at times (a not insignificant amount of weight). A stainless steel planter box of dimensions 12″×11″×2′-11.5″ (if this is the correct dimension, it is approx. 3 cu ft of soil, which usually weighs 60-100 lbs pcf saturated) filled with soil weighs about 97 pounds. With many planter boxes attached to the wall, significant weight is attached to the wall and cantilevered out in space away from the surface of the wall.

In addition, in a “living wall” installation, the wall must also be strong enough to support the structural load of the building itself. (just a note—in reality this is rarely an issue. It is a huge issue with roofs, because of the cantilever effect, but walls support the weight far better. I've never seen a wall that needed much work) Retrofitting walls that were not designed to support the weight of the containers with such containers puts extras stresses on the wall which can lead to cracking or structural failure. Unless the wall was designed or retrofitted to support the extra weight of the containers and the soil they contain, constructing a living wall on a wall that was not designed for such a load could damage or destroy the wall and possibly the building if the wall collapses under the extra weight of the containers. Retrofitting of walls to beef them up structurally can be expensive.

Further, a living wall structure allows the vines to attach themselves to the walls as they grow. (again, the main issue with living walls is more the complete coverage required, and the fact that it costs an exorbitant amount of money, which most of the time freaks out the owner of the project) This substantially raises the cost of removal of the system and hinders or completely eliminates the possibility of resurfacing or painting the wall because the vines are in the way and are attached to the wall.

In addition, living wall solutions are ten times as expensive as trellis systems. Further, living walls require more intensive irrigation efforts and require more labor than trellis systems to attach the containers to the wall.

Another prior art system to cover walls with plants is the G-Sky system which is depicted at g-sky.com/GWC_overview.aspx. In this system, stainless steel planter boxes of dimensions of about 12″×11″×2′-11.5″ are attached to 3′×5′ screens. The screens and planter boxes are then bolted to the front steel I-beam rails of a two panel maintenance scaffold grid of steel I-beams with maintenance walkways within the steel I-beam grid. The steel I-beams form boxes comprised of multiple, connected, two-box panels serving as the front and back surfaces of the array. The back surface of each box is bolted to the wall to be covered. The front surface of each box has three planter boxes attached to their screens attached to the I-beams of the front surface of the box by bolts and steel angle attachments that are welded to the I-beam. The planter boxes can be removed by unbolting them, but the brackets welded to the I-beams cannot be removed.

The depth of the I-beam boxes, i.e., the space between the front and rear panels, is large enough that it forms a maintenance walkway big enough for a human to walk behind the planter boxes on steel mesh flooring welded or otherwise attached to the I-beams and work on the plants or planter boxes and screens.

This G-Sky system has the advantage over living walls that the weight of the planter boxes is supported by the I-beam scaffold grid and not the wall. Further, the planter boxes are out away from the wall so the vines either do not attach themselves to the wall, preferring to climb the wire mesh attached to the planter box, or, if they do reach the wall and attach themselves, they can be easily removed using the maintenance walkways.

The disadvantage of the G-Sky system is that it is massive and expensive and labor intensive. Much time is needed to build the I-beam scaffold, weld all the mounting brackets to the I-beams, and bolt all the planter boxes to the mounting brackets.

### BRIEF DESCRIPTION OF THE DRAWINGS

FIG. 1 is a front view of the preferred embodiment with a two-panel trellis with planter modules integrated therein.

FIG. 2 is an end view taken from the perspective of line A-A′.

FIG. 3 is a side view taken from the perspective of line B-B′.

FIG. 4 is a more detailed, close up view of a “hole” in the trellis where the mounting structure for a planter module is fabricated.

FIG. 5 is a perspective view of the complete welded assembly of a section of the trellis ready to have two planter module dropped in and bolted into place.

FIG. 6 is a perspective view of the details of one corner of the mounting structure showing the angle bracket that is present at each corner of the “hole” in the trellis.

FIG. 7 is a detail view or area B in FIG. 1 looking down the Z axis showing where the angle bracket is located at one corner of the “hole”.

FIG. 8 is a perspective view of the angle bracket for each corner mount showing the bolt holes.

FIG. 9 is a perspective view of the preferred plastic planter module.

FIGS. 10 through 14 are perspective views of various alternative embodiments using two panel and single panel trellis.

### DETAILED DESCRIPTION OF THE VARIOUS EMBODIMENTS

The concept common to all embodiments is the notion of integrating a planter box into a trellis. Any planter box and any trellis will suffice. Any spacing of planter boxes on the trellis will suffice, and any mechanisms for securely attaching the planter boxes to the trellis and securely attaching the trellis to the wall will suffice. By secure, the inventor means any fastening system which will prevent the planter boxes from falling off the trellis, especially in high wind situations and any fastening system which will prevent the trellis from falling away from the wall in high winds or during an earthquake (within reason). The system does not have to be built to survive the most severe earthquakes, but should be built to survive the most common intensity of earthquake or less. Accordingly, the material and strength of the trellis should be such as to be able to withstand the forces encountered if the whole structure is subjected to a mild earthquake or high winds.

The trellis material is usually a single or double panel of rigid wire, but it can even be a wire rope net or mesh. The planter boxes are attached to the trellis either permanently or by a removable fastening system, and the trellis is attached to the wall. In the preferred embodiment, the trellis is made of 3/16″ diameter recycled steel which has been zinc plated for corrosion protection and powder coated.

The planter boxes allow plants to be grown in them while they are on the ground, and then the entire planter box, soil, plant and root system are hung within the trellis, and the trellis is mounted like trellises have been mounted in the prior art but with a fastening system which is strong enough to keep the trellis on the wall considering the weight of all the planter boxes, with the soil or planting mix therein possibly soaked with water.

The planter boxes are numerous enough and spaced on the trellis at intervals such that the plant only need grow 1 to 3 feet to provide good coverage for any size wall. In the preferred embodiment, each planter box is comprised of multiple molded plastic sides which is assembled after being shipped flat to the site. FIG. 9 is a picture of the box. The top, sides and bottom are identical moldings, and the front and back surface are custom molded, the front surface being the one which has four rows of four big holes and is seen in the perspective view of FIG. 9 closest to the observer. The big holes are for the plants to grow out. The back surface does not have big holes in it in the preferred embodiment since plants do not grow out of the back surface, but it could have holes in it for drainage, aeration of the root system, etc.

The way the box is used in the preferred embodiment is to assemble the box, but leave the top plate 9 off the assembly. A bag of soil or planting mix is then lowered into the box. The bag is made of non-woven polypropylene fabric which is commercially available and better known as landscape fabric. After the bag of soil is put in the box, the top plate 9 is attached to the rest of the box, and holes or slits are cut in the bag through the big holes on the front plate 11. Seedlings or seeds are then planted in the soil through the holes and the whole box is left on its back surface on the ground for several months to wait for the seedlings to grow and establish themselves in the soil. The box is then stood upright up on its end and dropped into its mounting rails at the position in the trellis grid where the box will be located and bolted into place. The details of the preferred embodiment for the trellis and its mounting for the boxes will be explained next.

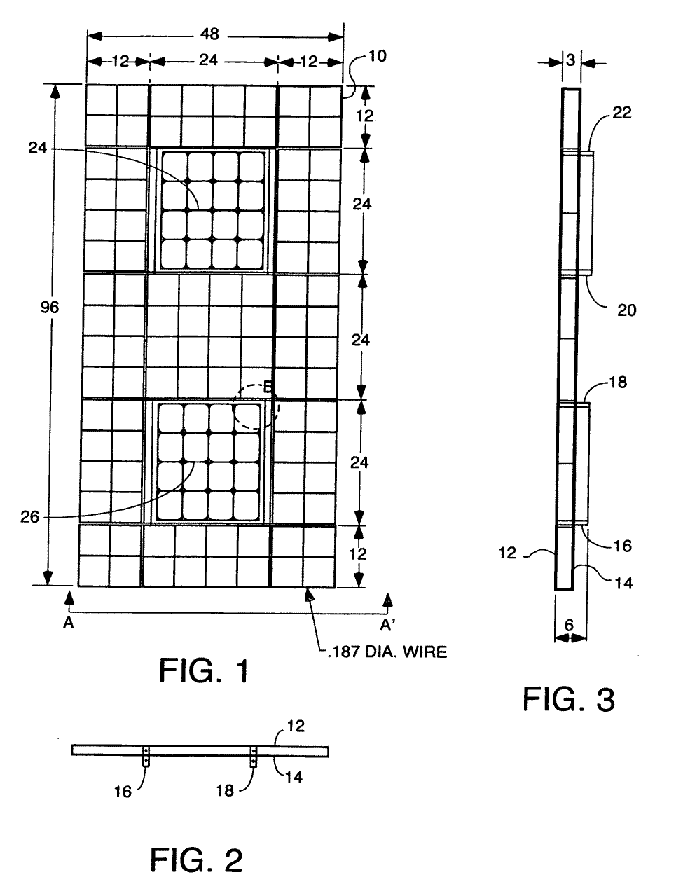

FIG. 1 is a front view of the preferred embodiment with a two-panel trellis with planter modules integrated therein.

FIG. 2 is an end view taken from the perspective of line A-A′.

FIG. 3 is a side view taken from the perspective of line B-B′.

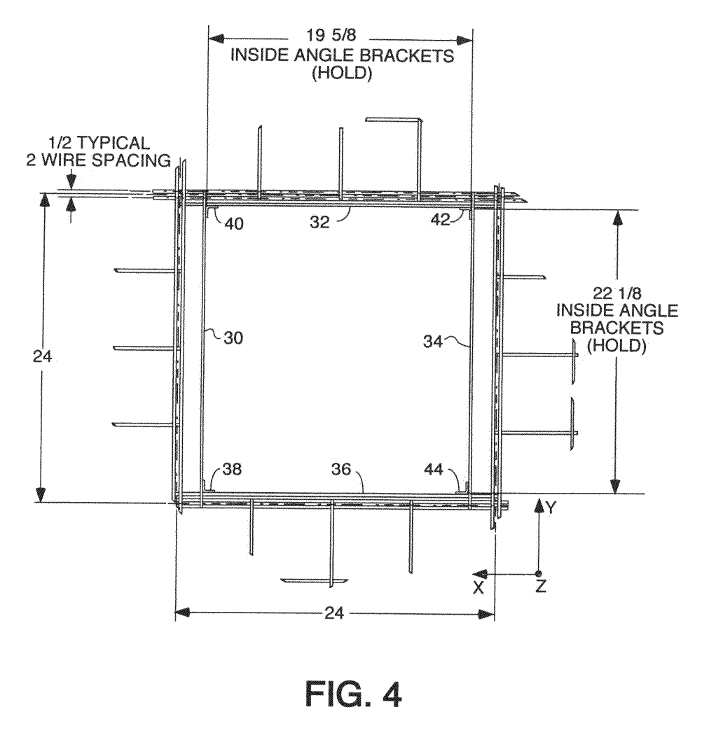

Referring jointly to FIGS. 1, 2 and 3, trellis 10 is comprised of a front panel 12 and a back panel 14. A column of mounting “holes” with mounting angle irons seen at 16, 18, 20 and 22 are seen in FIGS. 2 and 4. Two of the boxes like FIG. 9 are mounted in these angle irons at 24 and 26. In this particular embodiment, the front surface of the mounting box is flush with top surface 12 of the trellis.

FIG. 4 is a more detailed, close up view of a “hole” in the trellis where the mounting structure for a planter module is fabricated. Each planter box is mounted in an area of the trellis where the grid of the trellis has been removed and structural elements or wires 30, 32, 34 and 36 have been added to match the size of the planter module. If the planter module had dimensions which matched the size of a hole in the grid of the trellis if a 4×4 array of trellis squares were removed, these structural elements 32, 34, 36 and 38 would not be necessary, and the angle iron mounting rails to be described below could be welded to the trellis wire at the corners of the hole instead of at the corners of the added structural elements 30, 32, 34 and 36. The planter module is available commercially so its size does not exactly match a 4×4 array of trellis boxes which have been removed.

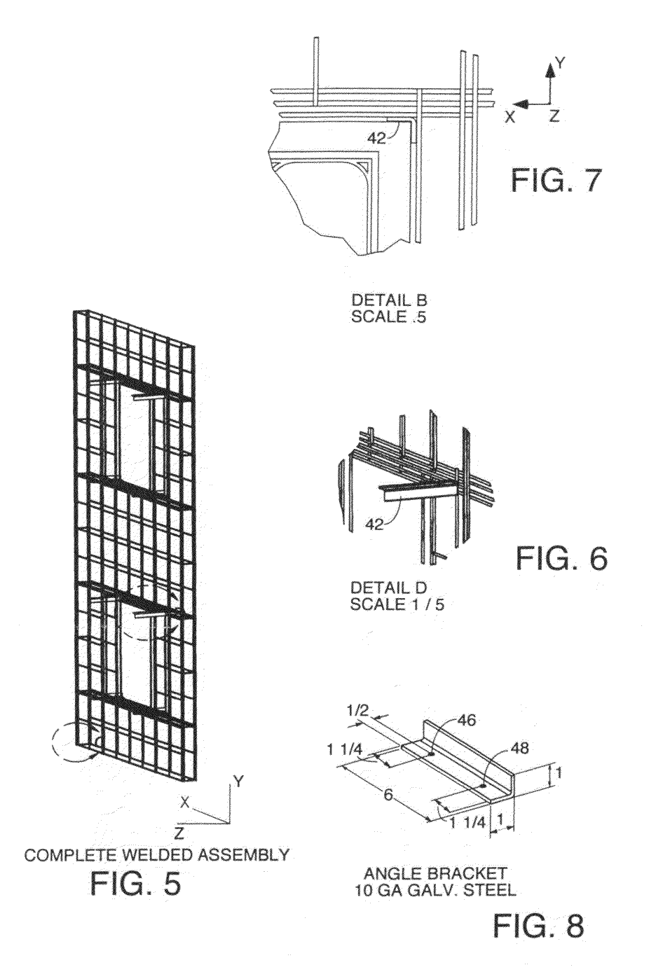

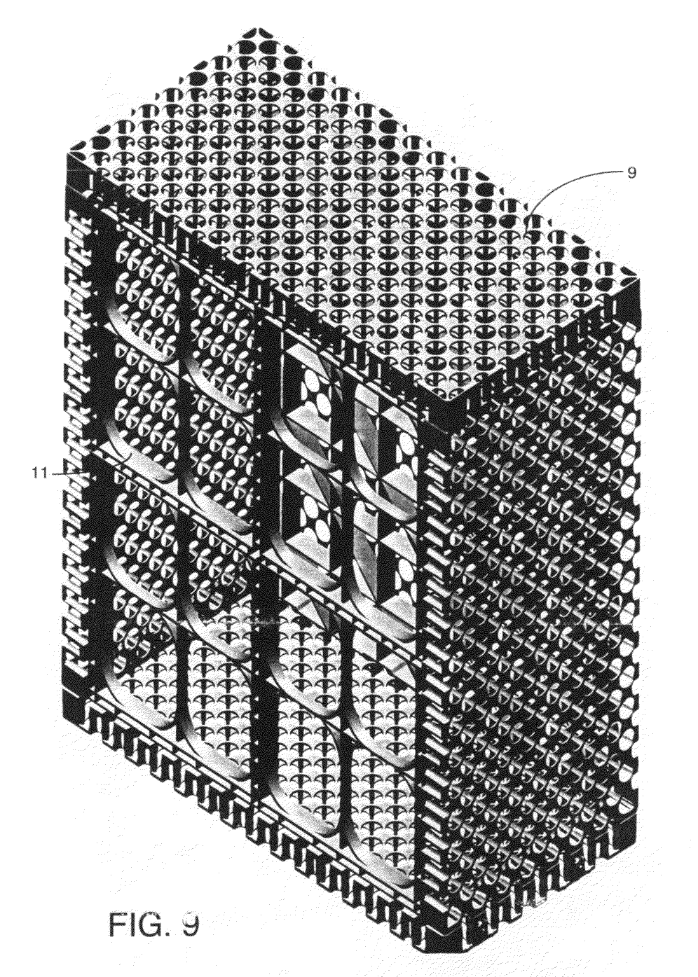

To mount the planter box in the trellis, four angle irons like are shown in FIG. 8 are welded at the corners of the “hole” in the preferred embodiment. They are shown at 38, 40, 42 and 44 in FIG. 4. The trellis forms a plane (each surface of the trellis forms its own plane) in the x-y plane in FIG. 4. The long dimension of the angle irons is parallel to the z axis which comes up out of the page. A perspective view of the complete welded assembly is shown in FIG. 5. A detail of one corner of the mounting structure for a planter module is shown in FIG. 7 with a perspective view shown in FIG. 6 for the angle iron 42 and the corner in which it is welded in FIG. 4. In embodiments where the trellis is manufactured out of some other material which is not conducive to welding, any other suitable fastening system which can withstand the load of the loaded planter modules can be used. For example, if the trellis is stainless steel or plastic, the angle iron mounting brackets can be bolted or glued to the trellis instead of welded, and the planter modules bolted to the angle irons.

In some alternative embodiments, the angle irons can be eliminated and a snap fit rail substituted at at least some corners of the mounting hole in the trellis. Each of these snap fit rails engages one or more teeth molded or machined into the edges of the planter module such that said planter box can be dropped into the mounting rails and the teeth on the edges of the planter module engage the snap fit rails such that the planter module can be simply dropped into its mounting hole while the trellis is horizontal (or pushed into its mounting hole is the trellis is already vertical and mounted to the wall of a building) and engage the snap fit rail and be mounted without the time needed to push bolts through the mounting holes on the rails, through the planter module and engage mounting holes on an angle iron on the other side of said planter module.

Also any type of mounting system to mount the trellis to the wall which can withstand the load of the trellis fully integrated with an array of planter modules which have been filled with soil may be used.

The planter module is then slid down into the box created by these angle iron “rails”. The angle irons have mounting holes 46 and 48 formed therein. After the planter box is slid down into the rails with the front surface (out of which the plants grown through the big holes) flush with the front surface of the trellis, long bolts are put into holes 46 and 48 and are pushed through the planter module and its soil until they pass through holes like holes 46 and 48 in the angle iron on the other side of the box. Nuts are then threaded onto the bolts to secure the box. Mounting structures like this can be formed at as many places as needed with a pitch as needed to completely cover the wall and only require the plants to grow a few feet to reach the next box.

FIG. 5 is a perspective view of the complete welded assembly of a section of the trellis ready to have two planter module dropped in and bolted into place.

FIG. 6 is a perspective view of the details of one corner of the mounting structure showing the angle bracket that is present at each corner of the “hole” in the trellis. A double trellis is shown, but the same mounting structure can be applied to a single trellis by welding the angle irons to the trellis wire.

FIG. 7 is a detail view or area B in FIG. 1 looking down the Z axis showing where the angle bracket is located at one corner of the “hole”.

FIG. 8 is a perspective view of the angle bracket for each corner mount showing the bolt holes 46 and 48.

FIG. 9 is a perspective view of the preferred plastic planter module. One of the big holes in the front plate is shown at 11. The top lid 9 can be removed to place a bag of soil in the box. The planter box in FIG. 9 is made of plastic but it can also be made of fiberglass, carbon fiber composite, stainless steel, powder coated steel, aluminum, brass or other materials that will not corrode excessively so as to compromise the structure. Plastic is the least expensive. The trellis must be made of sufficiently strong material to support the weight of the full planter modules. The planter modules come in two thicknesses at this time. One is 6″ thick with 4″ of soil. It weighs 75 lbs when full. The other size box is 10″ thick with 8″ of soil (the walls are 1 inch thick). It weighs 150 lbs when full. The planter modules are 20″×22″×6″ or 10″ in the preferred embodiment. Trellis wire of 3/16″ diameter steel has been found sufficiently strong for the pitch of planter modules shown in FIG. 1. Two layer trellis is preferred because it protects the foliage better, is stronger and is more attractive, however, it is more expensive than single layer trellis.

In the embodiment of FIG. 1, the planter box is mounted with the surface out from which the plants grow, flush with the front plane of the trellis (the plane farthest from the wall on which the trellis is mounted). The trellis can be up to 18″ away from the wall in embodiments using the size of box used in FIG. 1. Brackets are used to attach the trellis to the wall. The brackets can be welded to the trellis and bolted into concrete anchors in cement or masonry walls or using any other known fastening system. The planter modules can also be mounted so that their back surfaces are flush with the back plane of a two plane trellis or flush with the only plane of a single plane trellis. Other shapes for the planter modules can also be used.

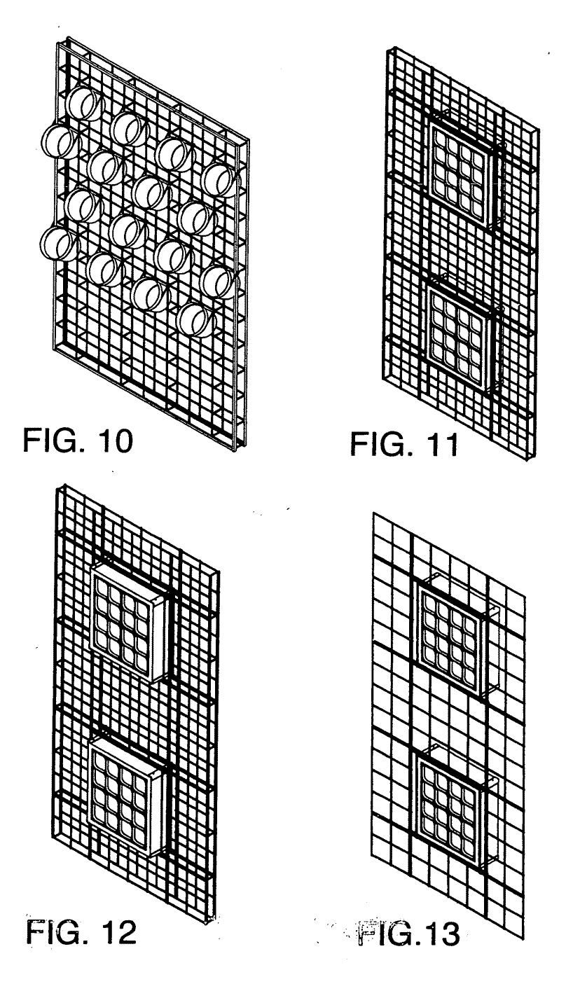

FIGS. 10 through 14 are perspective views of various alternative embodiments using two panel and single panel trellis. FIG. 10 is a perspective view of a two-layer trellis having round or oval planter modules mounted therein which are tilted upward at an angle so the plants can grow out of the top of the planter modules which really are more just conventional planting pots mounted in a trellis in an array. FIG. 11 is a perspective view of a two-layer trellis where the planter modules are mounted with the front surfaces flush with the back plane of the trellis which is closest to the wall upon which the trellis will be mounted.

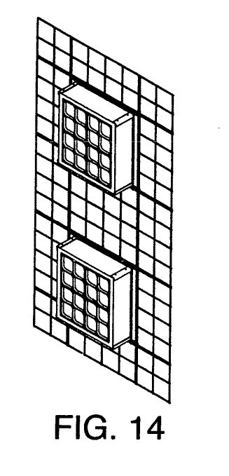

FIG. 12 is an embodiment using a two-layer trellis with the planter modules mounted with their back surfaces flush with the front surface of the trellis. FIG. 13 is an embodiment using a single-layer trellis with the planter modules mounted with their front surfaces flush with the plane of the trellis. FIG. 14 is an embodiment with a single-layer trellis with planter modules mounted with their back surfaces mounted flush with the plane of the trellis.

A trellis with integrated planter module system built according to the teachings of the invention can be constructed and cover a wall in a fraction of the time that other prior art systems require. A system according to the teachings of the invention also has the advantage over the living walls of the prior art that there is significantly less load placed on the wall. The cost of a system built according to the teachings of the invention is also far lower than the cost of rail mounted system and a “living wall” since it is faster and less expensive to mount the planter boxes on a trellis rather than the wall itself, and rails do not need to be attached to the wall to which planter boxes are attached. Maintenance and removal costs are also much lower since the whole trellis can be removed at once simply by disconnecting the trellis from the wall. The entire trellis can be replaced also simply by disconnecting the old trellis from the wall and connecting a new trellis with planter boxes already mounted to the wall at the same mounting locations as the old trellis.

What is claimed is:

1. An apparatus comprising:
a trellis suitable for plants to grow on;
an array of planter modules mounted to said trellis using means for mounting planter modules to a trellis; and
means for attaching the trellis to a wall of a building.

2. The apparatus of claim 1 wherein said trellis is a two-layer trellis and wherein each said planter module has a front surface out of which plants growing in said planter module grow.

3. The apparatus of claim 2 wherein said planter module is a plastic box with a square or rectangular cross-section which has a front surface with holes in it with sufficient size to allow plants to grow out therefrom and which has a top surface which, when removed, enables placement of soil or a bag of soil or planting mix in the interior of said planter module.

4. The apparatus of claim 3 wherein said trellis is 3/16 inch diameter, zinc plated steel wire which has been powder coated.

5. The apparatus of claim 2 wherein said planter module is mounted so that said front surface thereof is flush with a front plane of said trellis, said front plane being the plane farthest from said wall when said trellis is mounted on a wall.

6. The apparatus of claim 2 wherein said planter module is mounted so that said front surface of said planter module is flush with a back plane of said trellis, said back plane being the plane of said trellis closest to said wall when said trellis is mounted on a wall.

7. The apparatus of claim 1 wherein said trellis is a single plane trellis and wherein said planter module has a front surface out of which plants growing in said planter module grow and a back surface.

8. The apparatus of claim 7 wherein said planter module is mounted to said trellis such that said front surface of said planter module is flush with said plane of said trellis.

9. The apparatus of claim 7 wherein said planter module is mounted to said trellis such that said back surface of said planter module is flush with the plane of said trellis.

10. The apparatus of claim 1 wherein said means for mounting said planter module to said trellis is a set of angle irons, one at each corner of a hole in said trellis where a planter module is to be mounted, each angle iron welded to wires of said trellis and engaged with a corner of said planter module to mount said planter module to said trellis and help transfer the weight of said planter module to the structure of said trellis, each said angle iron having mounting holes formed therein through which bolts are passed, said bolts being long enough to pass completely through said angle iron and said planter module and pass through mating mounting holes in another angle iron engaged with another corner of said planting module.

11. The apparatus of claim 1 wherein said means for mounting said planter module to said trellis is glue.

12. The apparatus of claim 1 wherein said means for mounting said planter module to said trellis is a snap fit set of rails that engage snap fit teeth on the edges of said planter module.
